(19) United States
(12) Patent Application Publication
(10) Pub. No.: US 2008/0181062 A1
(43) Pub. Date: Jul. 31, 2008

(54) METHOD AND APPARATUS FOR CONTROLLING FOCUS OF AN OPTICAL INFORMATION STORAGE MEDIUM

(75) Inventors: Sung-hyun KIM, Yongin-si (KR); Young-jae Park, Yongin-si (KR); Tatsuhiro Otsuka, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/957,663

(22) Filed: Dec. 17, 2007

(30) Foreign Application Priority Data
Jan. 31, 2007 (KR) 2007-10123

(51) Int. Cl. G11B 7/00

(52) U.S. Cl. 369/44.28

(57) ABSTRACT

A method and apparatus for controlling a focus of an optical disk in an optical disk recording/reproducing apparatus are provided. A method of controlling focusing onto an optical information storage medium having a plurality of data layers during an interlayer jump by moving an object lens up and down includes receiving a focus jump command for a focus jump from a current data layer to a target data layer, performing spherical aberration correction on the target data layer, holding a focusing servo with respect to the current data layer, and performing the focus jump to the target data layer in which the performing of the focus jump includes applying an acceleration pulse to a focus control signal for controlling driving of the object lens, and terminating the application of the acceleration pulse when the level of a sum signal resulting from the summation of the amplitude of light reflected from the optical information storage medium and collected by a light detector is less than a predetermined level. As a result, the focus jump can be performed rapidly and accurately. Moreover, by performing spherical aberration correction again after the focus jump, compatibility among various types of optical information storage media can be increased.

### CROSS-REFERENCE TO RELATED APPLICATION

This application claims all benefits accruing under 35 U.S.C. §119 from Korean Patent Application No. 2007-10123, filed on Jan. 31, 2007, in the Korean Intellectual Property Office, the disclosure of which is incorporated herein by reference.

### BACKGROUND OF THE INVENTION

1. Field of the Invention

The present invention relates to optical information storage, and more particularly, to a method of and apparatus for controlling focusing during an interlayer jump of an optical information storage medium, such as an optical disk, that has a high-density capacity and multiple data layers, in which an object lens of a high numerical aperture (NA) and a light source are utilized to emit short wavelength light.

2. Related Art

General information storage media are widely used in optical pickup apparatuses for recording/reproducing information. Optical disks, which are an example of information storage media, are classified as Compact Disks (CDs) or Digital Versatile Disks (DVDs) according to their information storage capacity. Examples of recordable optical disks also include High-Definition (HD) DVDs or Blue-Ray Disks having a recording capacity of 15 GB or greater. As such, the information storage media have evolved to increase recording capacity. A representative approach to increasing the recording capacity is to shorten the wavelength of a recording light source and to increase the numerical aperture (NA) of an object lens.

FIG. 1 is a cross-sectional view of an example multi-layer optical disk. Referring to FIG. 1, the multi-layer optical disk 10 includes a plurality of data layers L0 through Ln, formed on a base substrate 12 and separated by a spacer layer Ls between adjacent data layers, and a transparent cover layer 14 to cover the data layers L0 through Ln on the base substrate 12.

As the wavelength of a light beam generated from a light source in an optical disk recording/reproducing apparatus (not shown) is shortened and the numerical aperture (NA) of an object lens (not shown) is increased, much spherical aberration occurs with a change in the thickness of a transparent cover layer 141 shown in FIG. 1, resulting in degradation of recording/reproduction signals. The amount of spherical aberration is expressed by a multi-order equation. In particular, when the numerical aperture (NA) of an object lens (not shown) is greater than 0.8, high-order aberration cannot be neglected and 4^{th} order spherical aberration should also be considered in the following Equation as follows:

$${W}_{40} = \frac{{n}^{2} - 1}{8 {n}^{3}} {NA}^{4} Δ d . \qquad ( 1 )$$

where n indicates the refractive index of a transparent cover layer 14, NA indicates the numerical aperture (NA) of an object lens, and Δd indicates a change in the thickness of the transparent cover layer 14.

As can be seen from Equation #1, much high-order spherical aberration is generated in an optical disk recording/reproducing apparatus for a multi-layer optical disk 10 using an object lens (not show) having a numerical aperture (NA) of 0.8 or greater. For example, to record information on or reproduce information from the multi-layer optical disk 10, as shown in FIG. 1, a laser beam is focused onto the first data layer L0 and information is recorded on or reproduced from the first data layer L0 which has undergone aberration correction. For recording or reproducing with respect to another data layer on an optical disk, the focus of the laser beam is moved to the target data layer, which is called a focus jump.

Generally, once an optical disk 10, as shown, for example, in FIG. 1, is loaded, an optical disk recording/reproducing apparatus determines the type of loaded disk 10, performs a focus pull-in operation with respect to a data layer on the optical disk 10 to be recorded or reproduced, performs a focus servo operation and a tracking servo operation, and then obtains control information, such as address information. The focus pull-in operation involves focusing a beam spot onto a data layer of an optical disk, after which subsequent focusing operations are performed. After spherical aberration correction is performed in such a way as to optimize an address signal or a reproduction signal, information is recorded or reproduced. In particular, in the case of an optical disk composed of a plurality of data layers, movement to another data layer may be made during recording or reproduction of the current data layer.

Hereinafter, a method of performing a focus jump from a current data layer to another data layer on an optical disk 10 during recording or reproduction of the current data layer of the optical disk 10 will be described. Specifically, FIGS. 2A-2C show a conventional method of performing a focus jump between data layers on an optical disk 10 in an optical disk recording/reproducing apparatus in response to application of a kick/brake signal.

For a focus jump from a first data layer L0 to a second data layer L1 of an optical disk 10 during recording or reproducing of the first data layer L0, a focus error signal FES, the state of a focus servo signal, and a focus control signal FOD change as shown in FIGS. 2A-2C.

In particular, upon receipt of a focus jump command during recording or reproduction of the first data layer L0 on the optical disk 10, as shown in FIG. 1, the state of the focus servo signal is changed to “OFF” at time to, and a kick pulse signal, that is, an acceleration pulse is applied to the focus control signal FOD, as shown in FIG. 2C. At this time, a focus actuator (not shown) moves an object lens (not shown) within an optical pickup along an optical axis according to the focus control signal FOD, as shown in FIG. 2C, and the focus of a light beam is moved up and down towards the second data layer L1 in accordance with the movement of the object lens (not shown). The focus error signal FES, as shown in FIG. 2A, is obtained using astigmatism and usually takes the form of an S curve in accordance with the movement of the object lens (not shown).

Thus, after increasing, the focus error signal FES, as shown in FIG. 2A, gradually decreases and then reaches a level TH at time t1, at which time the kick pulse signal is not applied any more. Although the kick pulse is not applied, the focus actuator moves the object lens (not shown) towards the second data layer L1 of an optical disk 10 by inertia. Once the focus error signal FES, as shown in FIG. 2A, gradually decreases to a level TL at time t2 in accordance with the movement of the object lens (not shown), a break pulse signal, that is, a deceleration pulse is applied to the focus control signal FOD, as shown in FIG. 2C. Since a sign of the break pulse signal is opposite to a sign of the kick pulse signal, the movement of the object lens is greatly reduced. When the focus error signal FES, as shown in FIG. 2A, passes through the lowest point and increases to the level TL at time t3 during the output of the brake pulse signal, the brake pulse signal is not applied any more and the state of the focus servo signal is changed to “ON”, thereby completing a focus jump from the first data layer L0 to the second data layer L1 of the optical disk 10.

When a level immediately prior to the output of the kick pulse signal is 0, the level TH is higher than 0 by ΔV1 and the level TL is lower than 0 by ΔV2.

As such, at the instant the state of the focus servo signal is changed to “OFF”, after an interlayer movement control signal is applied, the focus error signal FES, as shown in FIG. 2A, and the focus control signal FOD, as shown in FIG. 2C, for a target data layer on an optical disk 10 are monitored, thereby performing a focus pull-in operation if a predetermined condition is satisfied and thus performing a focus jump.

In the conventional method, at the time of a focus jump, the focus error signal FES, as shown in FIG. 2A, for the target data layer has to be in a good state for a stable focus pull-in operation in the target data layer on an optical disk 10.

FIGS. 3A and 3B show a focus error signal FES in first through third data layers L0 through L2 of an optical disk 10, which changes according to which data layer spherical aberration correction has been performed. For example, FIG. 3A shows a focus error signal when numerical aberration (NA) correction is performed for the first data layer L0 of the optical disk 10 for recording/reproduction of the first data layer L0. As shown in FIG. 3A, if numerical aberration (NA) has been corrected for the current first data layer L0, a first focus error signal FES0 for the first data layer L0 is superior to a third focus error signal FES2 for the third data layers L2 of the optical disk 10. Thus, when a focus jump is made to the third data layer L2 during recording/reproduction of the first data layer L0, the focus error signal FES2 for the target third data layer L2 is poor, distorted, or degraded, causing difficulty in detecting a focus pull-in point of time and thus causing a failure in the focus jump on an optical disk 10.

As a result, recording or reproduction of data may be interrupted, making it difficult to apply the conventional method of performing a focus jump to the high-density multi-layer optical disk.

### SUMMARY OF THE INVENTION

Several aspects and example embodiments of the present invention provide a method and apparatus for controlling focusing during an interlayer jump of a high-density multi-layer optical disk in which a focus control can be performed rapidly and accurately during such an interlayer jump.

Additional aspects and/or advantages of the invention will be set forth in part in the description which follows and, in part, will be obvious from the description, or may be learned by practice of the invention.

In accordance with an example embodiment of the present invention, there is provided a method of controlling a focus of an optical information storage medium having a plurality of data layers during an interlayer jump by moving an object lens up and down. The method includes receiving a focus jump command for a focus jump from a current data layer to a target data layer of an optical information storage medium, performing spherical aberration correction on the target data layer, holding a focusing servo with respect to the current data layer, and performing the focus jump to the target data layer, in which the performing of the focus jump includes applying an acceleration pulse to a focus control signal for controlling driving of the object lens, and terminating the application of the acceleration pulse when the level of a sum signal resulting from the summation of the amplitude of light reflected from the optical information storage medium and collected by a light detector is less than a predetermined level.

According to an aspect of the present invention, the termination of the application of the acceleration pulse may include terminating the application of the acceleration pulse when the level of the sum signal is lower than an average level of the sum signal prior to the application of the acceleration pulse.

According to another aspect of the present invention, the termination of the application of the acceleration pulse may include terminating the application of the acceleration pulse when the level of the sum signal for a data layer immediately previously to the target data layer of the optical information storage medium is lower than an average level of the sum signal prior to the application of the acceleration pulse.

According to another aspect of the present invention, the performing of the focus jump may include applying a signal of a level corresponding to the average level of the focus control signal prior to the application of the acceleration pulse to the focus control signal after the termination of the application of the acceleration pulse.

According to another aspect of the present invention, the method may further include applying a deceleration pulse to the focus control signal when the level of a focus error signal calculated from the amplitude of the light is lower than a first level.

According to another aspect of the present invention, the first level may be lower than the average level of the focus error signal prior to the application of the acceleration pulse.

According to another aspect of the present invention, the amplitude of the deceleration pulse may be reduced when a first time, from the end point of time of the application of the acceleration pulse to the start point of time of the application of the deceleration pulse, is longer than a reference time, and the amplitude of the deceleration pulse may be increased when the first time is shorter than the reference time.

According to another aspect of the present invention, the performing of the spherical aberration correction on the target data layer may include performing spherical aberration correction on at least one data layer between the current data layer and the target data layer of the optical information storage medium.

According to another aspect of the present invention, the method may further include counting the number of data layers of the optical information storage medium after the spherical aberration correction with respect to the target data layer.

According to another aspect of the present invention, the counting of the number of data layers may include outputting a first signal resulting from comparison of the sum signal with a first slice level, outputting a second signal resulting from band pass filtering with respect to the sum signal, outputting a third signal resulting from comparison of the second signal with a second slice level, outputting a fourth signal resulting from an operation with respect to the first signal and the third signal, and determining the number of data layers of the optical information storage medium based on the fourth signal.

According to another aspect of the present invention, the method may further include performing spherical aberration correction again after the focus jump.

In accordance with another example of the present invention, there is provided an optical information storage medium reproducing/recording apparatus including an optical pickup unit arranged to collect light reflected from a loaded optical information storage medium having a plurality of data layers onto a light detector by moving an object lens up and down, a radio frequency (RF) amplification unit arranged to output a sum signal resulting from the summation of the amplitude of the collected light and a focus error signal resulting from another calculation on the amplitudes of the collected light, a servo signal processing unit arranged to hold a focusing servo with respect to a current data layer and performing a focus jump to a target data layer upon input of a focus jump command for the focus jump from the current data layer to the target data layer from outside, a spherical aberration correction unit arranged to perform spherical aberration correction on the target data layer upon input of the focus jump command, and a driving unit arranged to drive the optical pickup unit using a signal output from the servo signal processing unit, in which the servo signal processing unit applies an acceleration pulse to a focus control signal for controlling driving of the object lens and terminates the application of the acceleration pulse when the level of the sum signal is less than a predetermined level.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a cross sectional view of a multi-layer optical disk;

FIGS. 2A-2C show a conventional method of performing a focus jump between data layers on an optical disk in response to application of a kick/brake signal;

FIGS. 3A and 3B show focus error signals in first through third data layers of a disk, which change according to which layer spherical aberration correction has been performed on;

FIG. 4 shows the structure of an optical disk recording/reproducing apparatus according to an example embodiment of the present invention;

FIG. 5 is an enlarged view of an optical pickup unit shown in FIG. 4 according to an example embodiment of the present invention;

FIG. 6A illustrates the form of light collected by a four-division light detector when a light beam accesses a data layer of an optical disk;

FIG. 6B illustrates the form of light collected by the four-division light detector when a light beam is accurately focused onto a data layer of an optical disk;

FIG. 6C illustrates the form of light collected by the four-division light detector when a light beam moves away from a data layer of an optical disk;

FIGS. 7A-7C show a focus error signal generated according to the light forms shown in FIGS. 6A-6C;

FIG. 8 is a flowchart of a method of performing a focus jump according to an example embodiment of the present invention;

FIGS. 9A-9F show signals that are output during a focus jump from a first data layer to a second data layer on an optical disk according to an example embodiment of the present invention;

FIG. 10 is a view for explaining determination of a kick pulse signal based on a total-sum signal according to an example embodiment of the present invention;

FIGS. 11A-11G show signals that are output during a focus jump from a first data layer to a third data layer on an optical disk according to another example embodiment of the present invention;

FIG. 12 is a block diagram of a data layer determination unit of a servo signal processing unit according to an example embodiment of the present invention; and

FIGS. 13A-13E show signals output from components of the data layer determination unit shown in FIG. 12.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

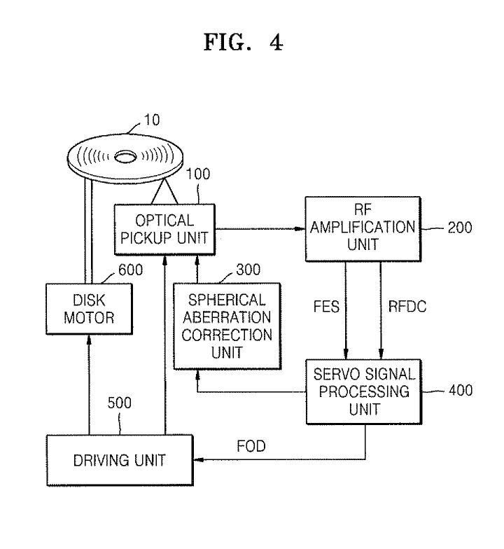

FIG. 4 shows the structure of an optical disk recording/reproducing apparatus according to an example embodiment of the present invention. For purposes of brevity, the optical disk recording/reproducing apparatus, albeit in whole or in part, can also be referred to as a drive system which can be internal (housed within a host) or external (housed in a separate box that connects to a host (not shown)). An optical disk can be any high-density medium, such as blue-ray disc (BD) and advanced optical disc (AOD); however, other high-density multi-layer optical disks can also be utilized. In addition, such an optical disk recording/reproducing apparatus may be a single apparatus, or may be separated into a recording apparatus (i.e., digital video disc recorder “DVDR”) and a reading apparatus (i.e., compact disc player “CDP” or digital video disc player “DVDP”).

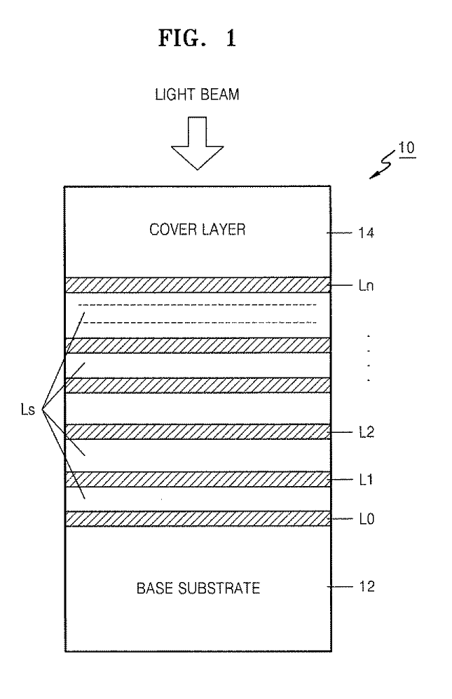

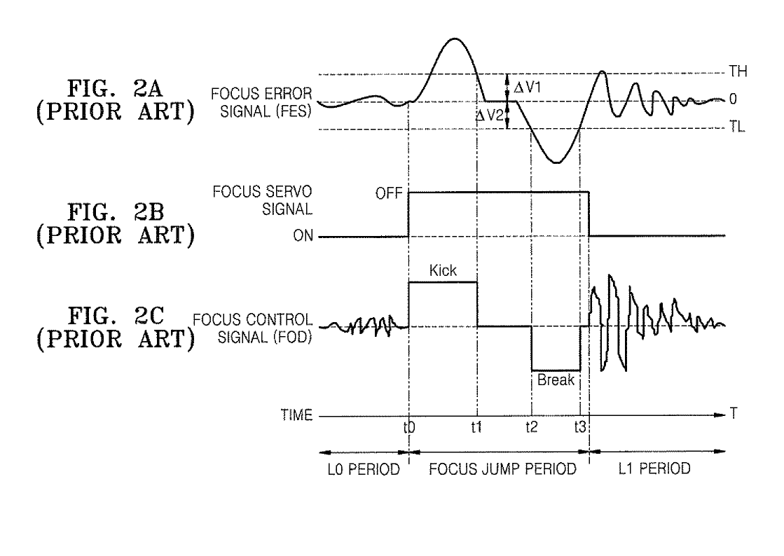

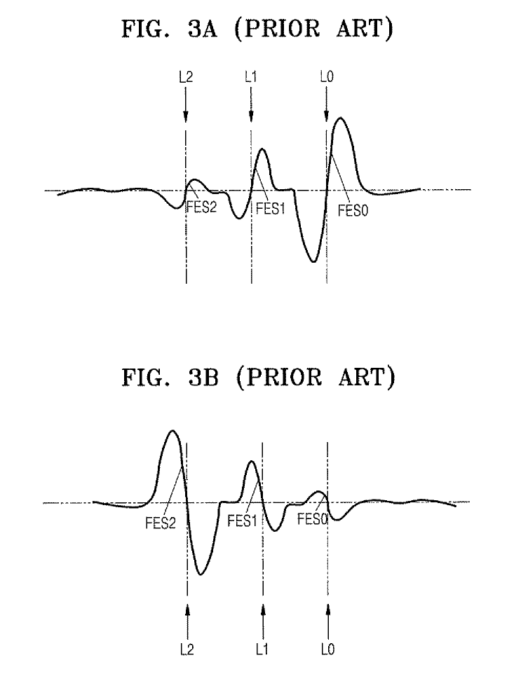

Referring to FIG. 4, the optical disk recording/reproducing apparatus includes an optical pickup unit 100, a radio frequency (RF) amplification unit 200, a spherical aberration correction unit 300, a servo signal processing unit 400, a driving unit 500, and a disk motor 600 arranged to drive an optical disk 10, as shown, for example, in FIG. 1.

The optical pickup unit 100 is driven by a tracking actuator (not shown) for tracking servo control and a focusing actuator (not shown) for focus servo control, and emits light to a loaded optical disk 10 in order to convert a received light beam into an electrical RF signal. In other words, information recorded on an optical disk 10 is optically picked up, is converted into the electrical RF signal, and then is output to the RF amplification unit 200.

The RF amplification unit 200 amplifies the RF signal output from the optical pickup unit 100. The RF amplification unit 200 performs a logic operation [(A+C)−(B+D)] on light input from a four-division light detector included in the optical pickup unit 100 using astigmatism in order to output a focus error signal FES, and performs a logic operation (A+B+C+D) on the light input from the four-division light detector in order to output a total-sum signal RFDC.

The spherical aberration correction unit 300 focuses a light beam onto a designated one of a plurality of data layers of an optical disk 10 and then focuses the light beam onto another data layer of an optical disk 10 based on the focused data layer so as to compensate for a difference between thicknesses of data layers of the optical disk 10.

Upon receipt of a focus jump command from the outside, the spherical aberration correction unit 300 also performs spherical aberration correction on a target data layer of the optical disk 10, while stopping tracking, but maintaining focusing, with respect to a currently recorded or reproduced data layer of the optical disk 10.

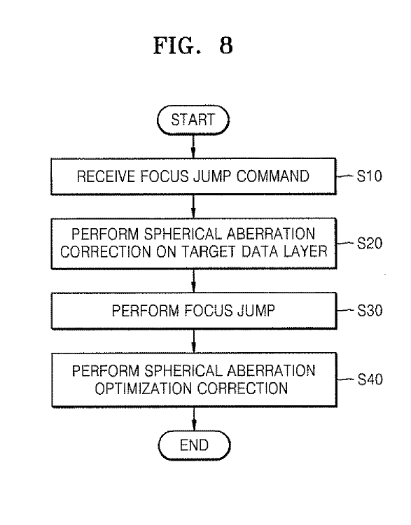

The servo signal processing unit 400 receives the focus error signal FES and the total-sum signal RFDC from the RF amplification unit 200, and outputs a focus drive signal FOD to the driving unit 500 in order to move an object lens (not shown) included in the optical pickup unit 100 up and down perpendicularly relative to the optical disk 10, thereby controlling the focus position of the light beam. Upon receipt of a focus jump signal from the outside, the servo signal processing unit 400 moves the focus of the light beam between data layers of the optical disk 10 according to the focus error signal FES and the total-sum signal RFDC, as will be described in detail with reference to FIGS. 8 through 13.

The driving unit 500 includes a focus actuator (not shown) and a focus drive (not shown), and drives the focusing actuator according to the focus drive signal FOD output from the servo signal processing unit 400 to move the object lens (not shown) up and down perpendicularly relative to the optical disk 10.

The disk motor 600 rotates the optical disk 10 using a constant linear velocity (CLV) method or a constant angular velocity (CAV) method according to a disk drive signal output from the driving unit 500.

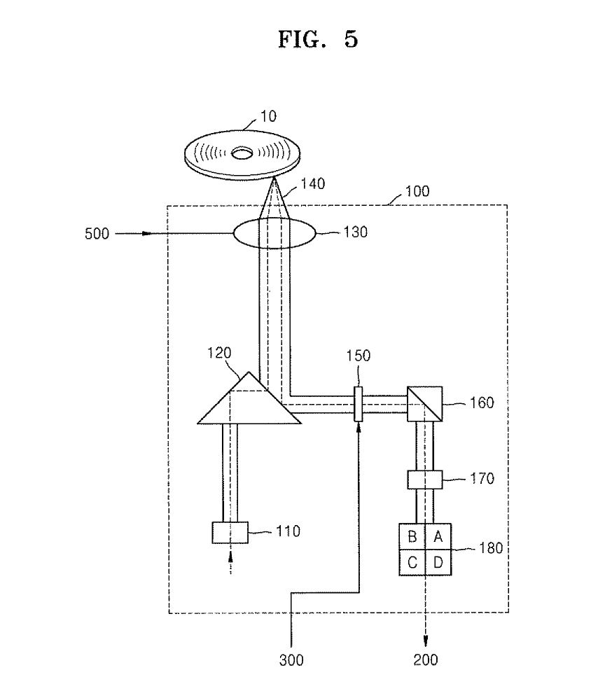

Turning now to FIG. 5, an enlarged view of an optical pickup unit 100 according to an example embodiment of the present invention is shown. Referring to FIG. 5, the optical pickup unit 100 includes a laser diode (LD) 110, a reflection mirror 120, an object lens 130, a light beam 140, a collimator lens 150, a beam splitter 160, a condenser lens 170, and a four-division light detector 180 (e.g., a photo-detector).

Once the LD 110 enters an “ON” state, light emitted from the LD 110 is reflected by the reflection mirror 120 and then is incident to the object lens 130. The light beam 140 is output from the object lens 130 and is collected by the optical disk 10. The reflected light is split by the beam splitter 160 after passing through the collimator lens 150. At this time, the spherical aberration correction unit 300 delivers a signal to the collimator lens 150 to correct spherical aberration occurring due to a thickness variation of a transparent cover layer of the optical disk 10, as shown, for example, in FIG. 1, and the collimator lens 150 adjusts a focus position to be on the optical disk by moving right and left. Although the optical pickup unit 100 uses the collimator lens 150 for spherical aberration correction herein, a beam expander or a liquid crystal lens for spherical aberration correction may also be utilized.

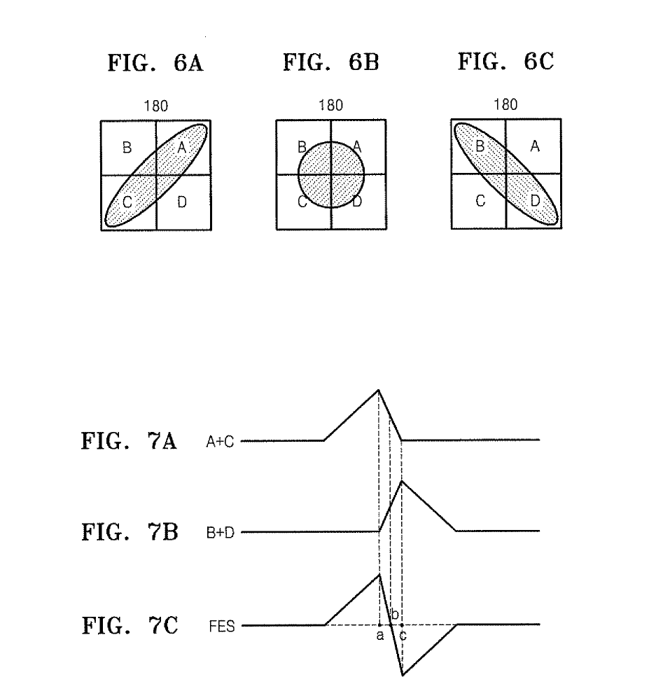

The light split by the beam splitter 160 is collected by the condenser lens 170 and the collected light is delivered to the four-division light detector 180. The four-division light detector 180 delivers the light incident on regions “A”, “B”, “C”, and “D”, as shown in FIGS. 6A-6C, in accordance with the movement of the object lens 130 to the RF amplification unit 200.

As discussed previously, the RF amplification unit 200 performs a logic operation [(A+C)−(B+D)] on the light input from the four-division light detector 180 using astigmatism in order to output the focus error signal FES, and performs a logic operation (A+B+C+D) on the light input from the four-division light detector 180 in order to output the total-sum signal RFDC. The RF amplification unit 200 then outputs the generated focus error signal FES and the total-sum signal RFDC to the servo signal processing unit 400.

Hereinafter, a process of generating the focus error signal FES in accordance with the movement of the object lens 130 using astigmatism will be described with reference to FIGS. 6A-6C and FIGS. 7A-7C.

FIG. 6A illustrates the form of light collected by the four-division light detector 180 when a light beam accesses a data layer of the optical disk 10, as shown, for example, in FIG. 1; FIG. 6B illustrates the form of light collected by the four-division light detector 180 when a light beam is accurately focused onto a data layer of the optical disk 10; FIG. 6C illustrates the form of light collected by the four-division light detector 180 when a light beam moves away from a data layer of the optical disk 10, and FIGS. 7A-7C show a focus error signal FES generated according to the forms of light shown in FIGS. 6A-6C.

For example, when the light beam passing through the object lens 130 accesses a data layer of an optical disk 10, the light collected by the four-division light detector 180 is not uniformly collected over the four regions, “A”, “B”, “C”, and “D”; rather, the light is collected mostly on region “A” and region “C”, as shown in FIG. 6A. Thus, as shown in FIGS. 7A-7B, at a point a, (A+C) has a maximum value, while (B+D) has a minimum value, and thus the focus error signal FES has a maximum value, as shown in FIG. 7C.

When the light beam passing through the object lens 130 is being accurately focused onto a data layer of the optical disk 10, the light collected by the four-division light detector 180 is uniformly collected over the four regions as shown in FIG. 6B and thus the focus error signal FES has a value of zero “0”.

When the light beam passing through the object lens 130 moves away from a data layer of the optical disk 10, the light collected by the four-division light detector 180 is not uniformly collected over the four regions; rather, the light is collected mostly on region “B” and region “D”, as shown in FIG. 6C. Thus, as shown in FIGS. 7A-7B, at a point c, (A+C) has a minimum value, while (B+D) has a maximum value, and thus the focus error signal FES has a minimum value, as shown in FIG. 7C.

As such, according to astigmatism, the focus error signal FES takes the form of an S curve in accordance with the movement of the object lens 130.

Hereinafter, a method of performing a focus jump to another data layer on an optical disk during reproduction or recording with respect to the current data layer will be described herein below.

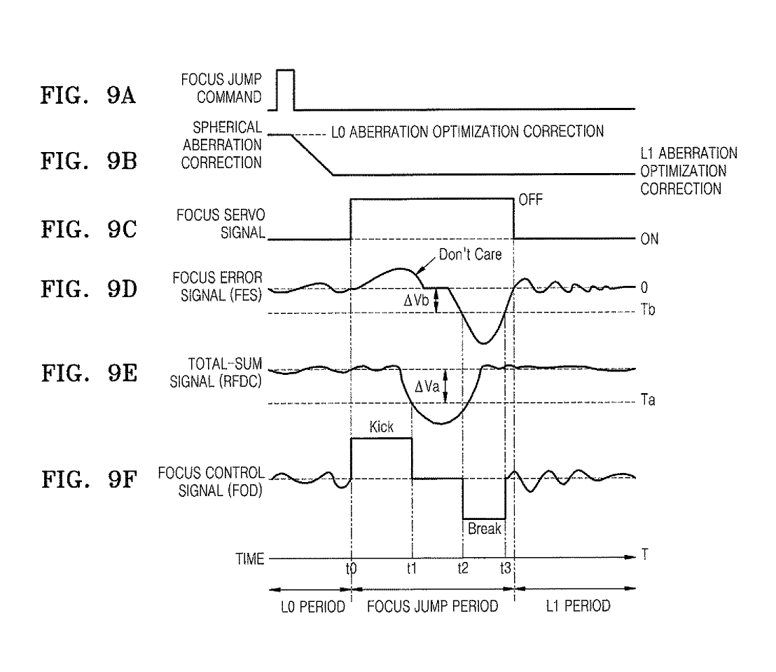

FIG. 8 is a flowchart of a method of performing a focus jump on an optical disk according to an example embodiment of the present invention, and FIGS. 9A-9F show signals that are output during a focus jump from a first data layer L0 to a second data layer L1 on an optical disk 10 according to an example embodiment of the present invention. Repetitive descriptions regarding the output signals shown in FIGS. 9A-9F will be omitted for the sake of brevity.

When a focus jump command is received for a focus jump from a first data layer L0 to a second data layer L1 during recording or reproduction of the first data layer L0 in operation S10, the spherical aberration correction unit 300 performs spherical aberration correction on the second data layer L1 of the optical disk 10, while stopping tracking, but maintaining focusing, with respect to the currently recorded or reproduced first data layer L0 of the optical disk 10 in operation S20.

In other words, as shown in FIG. 9A, upon receipt of a focus jump command, the spherical aberration correction unit 300 having performed spherical aberration correction on the first data layer L0 of the optical disk 10 performs spherical aberration correction on the second data layer L1 of the optical disk 10, as shown in FIG. 9B.

After completion of the spherical aberration correction with respect to the second data layer L1 of the optical disk 10, the servo signal processing unit 400 performs a focus jump from the first data layer L0 to the second data layer L1 of the optical disk in operation S30.

As shown in FIG. 9C, a focus servo signal for the first data layer L0 is held in an “OFF” state from t0 and a kick pulse signal, that is, an acceleration pulse is applied to the focus control signal FOD, as shown in FIG. 9F. At this time, the focusing actuator included in the optical pickup unit 100, shown in FIG. 4, moves the object lens 130 included in the optical pickup unit 100 along an optical axis according to the focus control signal FOD and the focus of the light beam moves towards the second data layer L1 of the optical disk 10 in accordance with the movement of the object lens 130.

Once the level of the total-sum signal RFDC, as shown in FIG. 9E, is reduced by ΔVa from its level immediately prior to the application of the kick pulse signal and thus reaches a level Ta at t1, the kick pulse signal is not applied any more. At this time, unlike the conventional focus jump method, the focus error signal FES, as shown in FIG. 9D, does not affect the end point of time of the application of the kick pulse signal (Don't care). This is because the spherical aberration correction unit 300 has already performed optimal correction with respect to the second data layer L1 of the optical disk 10 and thus the focus error signal FES of the first data layer L0 is degraded by spherical aberration, increasing a possibility of failing to obtain an S curve having the original signal amplitude. In particular, since the focus error signal FES, as shown in FIG. 9E, is affected more as thicknesses of data layers of the optical disk 10 increases, the accuracy of the focus error signal FES is reduced.

On the other hand, the total-sum signal RFDC, as shown in FIG. 9E, is hardly degraded by spherical aberration corrections and has a minimum value when the light beam passes through an intermediate position between the first data layer L0 and the second data layer L1 of the optical disk 10. For this reason, the degree of change of the total-sum signal RFDC can be clearly distinguished among data layers of the optical disk 10. Thus, it may be more reliable to use the level of the total-sum signal RFDC in determining the end point of time of the application of the kick pulse signal rather than to use the level of the focus error signal FES.

After the application of the kick pulse signal is terminated, an average value of the focus control signal FOD of the first data layer L0 immediately prior to the application of the kick pulse signal or the level of a low-pass filtered signal of the focus control signal FOD is applied to the focus control signal FOD.

At this time, although the kick pulse signal is not applied any more, the focusing actuator (not shown) slowly moves the object lens 130 towards the second data layer L1 of the optical disk 10 due to inertia. The focus error signal FES, as shown in FIG. 9D, is gradually reduced in accordance with the movement of the object lens 130. When the focus error signal FES is reduced by ΔVb from the level immediately prior to the application of the kick pulse signal and thus reaches a level Tb at t2, a break pulse signal that is a deceleration pulse is applied to the focus control signal FOD, as shown in FIG. 9F.

The level Ta is lower by ΔVa than the average level of the total-sum signal RFDC that is applied to the first data layer L0 of the optical disk 10 immediately prior to the application of the kick pulse signal, and the level Tb is lower by ΔVb than 0 when the average level of the focus error signal FES that is applied to the first data layer L0 of the optical disk 10 immediately prior to the application of the kick pulse signal is zero “0”.

At this time, since the spherical aberration correction unit 300 has already performed spherical aberration correction on the second data layer L1 of the optical disk 10, the focus error signal FES of the second data layer L1 is not distorted by spherical aberration and thus is in a good state. Therefore, although the break pulse signal is applied when the focus error signal FES reaches a predetermined level as in the conventional focus jump method, the break pulse signal can be applied at an accurate point of time because spherical aberration correction has already been performed on the second data layer L1 of the optical disk 10.

Once the break pulse signal is applied, the moving speed of the object lens 130 is sharply reduced. When the focus error signal FES increases again up to the level Tb at t3 after passing through the minimum value during the output of the break pulse signal, the break pulse signal is not applied any more and the focus servo signal, as shown in FIG. 9C, enters an “ON” state.

The spherical aberration correction unit 300 performs spherical aberration correction on the second data layer L1 of the optical disk 10 again in order to optimize a recording or reproduction signal of the second data layer L1 in operation S40, and then terminates the focus jump between data layers of the optical disk 10.

For accurate detection of the total-sum signal RFDC, a method of detecting the total-sum signal RFDC that determines the end point of time of the application of the kick pulse signal will be described with reference to FIG. 10. The method of detecting the total-sum signal RFDC, as shown in FIG. 9E, can be implemented with hardware or software. In terms of software, during recording or reproduction of the first data layer L0 of the optical disk 10, a memory (not shown) of the servo signal processing unit 400 stores the level of the total-sum signal RFDC input to the servo signal processing unit 400. In other words, the average level or the level of a low-pass filtered signal of the total-sum signal RFDC prior to a focus jump is stored and the stored level is compared with the level of the total-sum signal RFDC stored during the application of the kick pulse signal. Thus, when a difference between those levels exceeds ΔVa, the servo control signal processing unit 400 terminates the application of the kick pulse signal.

However, since the focus jump is performed at high speed, it is not easy to store levels in the memory of the servo signal processing unit 400 and to perform a logic operation on levels. Therefore, such a method may be implemented with hardware as follows.

FIG. 10 is a view for explaining determination of the kick pulse signal based on the total-sum signal RFDC according to an example embodiment of the present invention. As shown in FIG. 10, a comparison unit 410 of the servo signal processing unit 400 includes a non-inverting terminal (±) and an inverting terminal (−). The detected total-sum signal RFDC is input to the non-inverting terminal (±) and ΔVa is input to the inverting terminal (−). The comparison unit 410 performs a logic operation so that the kick pulse signal is applied to the focus control signal FOD, as shown in FIG. 9F, when a result of subtracting ΔVa from the total-sum signal RFDC is greater than a predetermined value (the level Ta in FIG. 9) and the kick pulse signal is not applied to the focus control signal FOD when the result is less than the predetermined value.

To improve the stability of the focus jump on an optical disk 10, the amplitude of the break pulse signal may be adjusted during the application of the break pulse signal. In other words, if the moving speed of the object lens 130 is sharply reduced at the point of time of the application of the break pulse signal (t2) and thus movement of the focus is made in the opposite direction to the direction towards the target data layer, i.e., the focus is moved back to the current data layer, after the application of the break pulse signal, the focus jump may fail due to the wrong detection of the level of the focus error signal FES.

If the time Δt from t1 at which the application of the kick pulse signal is terminated to t2 at which the application of the break pulse signal starts is greater than a reference time, it means that the moving speed of the object lens 130 is low. Therefore, in this case, the focus of the object lens 130 is prevented from moving in the opposite direction to the direction towards the target data layer by reducing the amplitude of the break pulse signal.

If the time Δt is less than the reference time, the moving speed of the object lens 130 is high. Therefore, in this case, a focus pull-in operation may be performed stably by increasing the amplitude of the break pulse signal.

Although the method of performing a focus jump according to an example embodiment of the present invention has been described with reference to an optical disk having two data layers, an optical disk having three or more data layers can also be utilized. In other words, a focus jump in an optical disk having at least three data layers may also be performed by movement from a first data layer to a second data layer on the optical disk, and then from the second data layer to a third data layer according to an example embodiment of the present invention.

However, for a focus jump from the first data layer directly to the third data layer on an optical disk, for example, it is necessary to previously count the number of data layers.

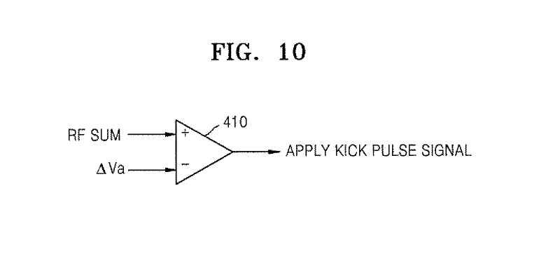

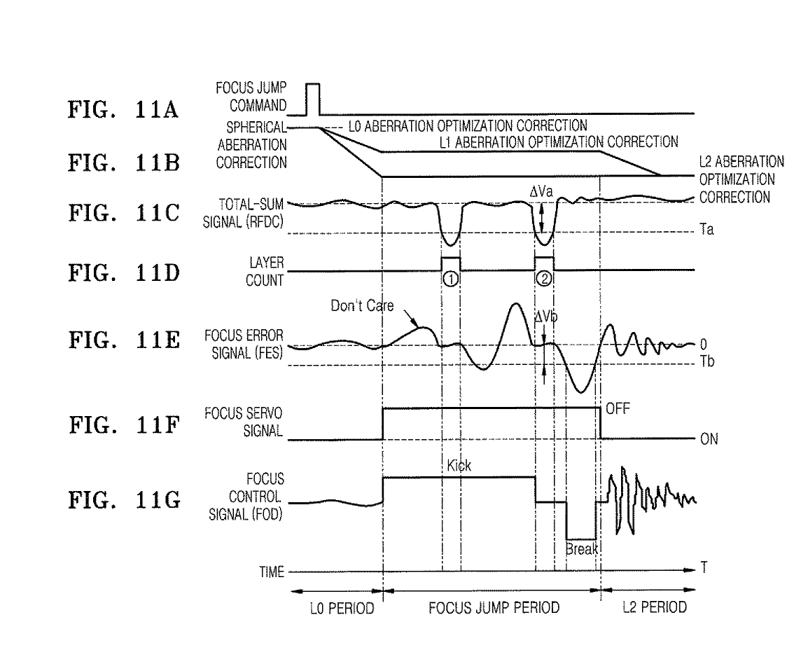

FIGS. 11A-11G show signals that are output during a focus jump from a first data layer L0 to a third data layer L2 on an optical disk 10 according to another example embodiment of the present invention. Although the third data layer L2 is taken as an example for convenience of explanation, the focus jump may also be performed to a data layer on an optical disk 10 that is higher than the third data layer L2.

Upon receipt of a focus jump command for a focus jump, as shown in FIG. 11A, from the first data layer L0 to the third data layer L2 on an optical disk 10 during recording or reproduction of the first data layer L0, the spherical aberration correction unit 300 performs spherical aberration correction on the third data layer L2 of the optical disk 10, as shown in FIG. 11B, while stopping tracking, but maintaining focusing, with respect to the currently recorded or reproduced first data layer L0 of the optical disk 10.

As in an example embodiment of the present invention as described in connection with FIGS. 9A-9F, the focus servo signal for the first data layer L0 on the optical disk 10, as shown in FIG. 11F, is held in an “OFF” state and the kick pulse signal that is an acceleration pulse is applied to the focus control signal FOD, as shown in FIG. 11G. After the light beam has passed through the second data layer L1 that is immediately previous to the target third data layer L2 of the optical disk 10, the application of the kick pulse signal continues until the level of the total-sum signal RFDC is reduced by ΔVa from a level immediately prior to the application of the kick pulse signal and thus reaches the level Ta as shown in FIG. 11C.

The application of the break pulse signal that is a deceleration pulse is the same as in an example embodiment of the present invention as described in connection with FIGS. 9A-9F, and thus will not be described herein.

Although spherical aberration of the target data layer L2 may be corrected if the focus jump command is input as in the example embodiment of the present invention as described in connection with FIGS. 11A-11G, the total-sum signal RFDC may become unstable when a distance between data layers is long. Therefore, the second data layer L1 between the current data layer L0 and the target data layer L2 may also be subject to spherical aberration correction.

When an optical disk 10 is composed of at least three data layers, the end point of time of the application of the kick pulse signal can be accurately detected by counting the number of data layers using a layer count signal.

In particular, as shown in FIG. 11C, the total-sum signal RFDC may be slice level processed in order to distinguish a data layer on an optical disk 10. Thus, in the case of a focus jump from the first data layer L0 to the third data layer L2 of the optical disk 10, the kick pulse signal is applied to move the focus of the light beam by two data layers (n) at a time, the level of the total-sum signal RFDC, as shown in FIG. 11C, after counting of a single data layer (n−1) is detected, and the application of the kick pulse signal is terminated at a predetermined level. Thus, as shown in FIG. 1 the first data layer L0 and the second data layer L1 are counted respectively as in (1) and (2) of FIG. 11D, and the end point of time of the application of the kick pulse signal is determined based on the level of the total-sum signal RFDC, as shown in FIG. 11C.

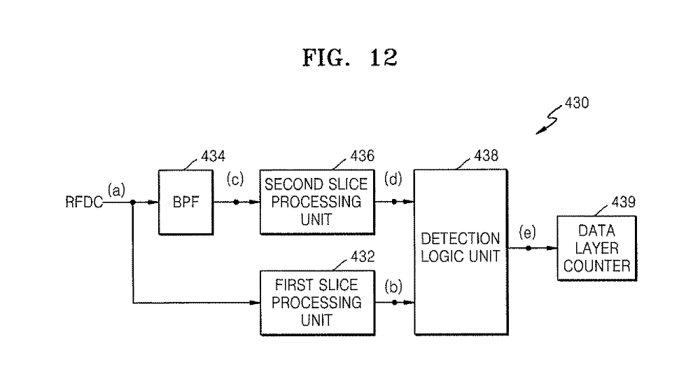

The data layers of the optical disk 10 may be counted using slice levels as mentioned above, but slice processing may be inaccurate when a distance between data layers is less than 15 μm. Therefore, the number of data layers can be counted using a band pass filter (BPF) as in FIG. 12.

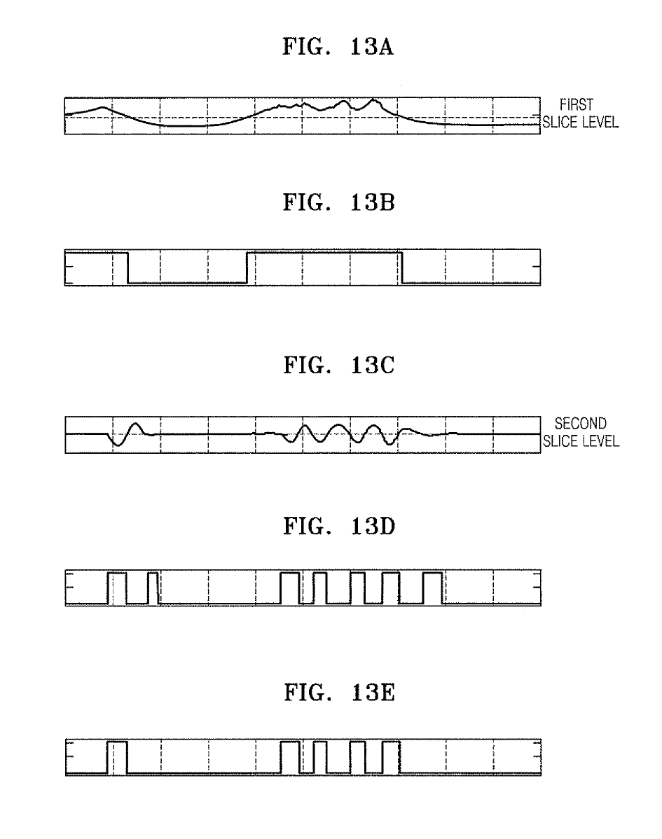

FIG. 12 is a block diagram of a data layer determination unit 430 included in a servo signal processing unit 400 according to an example embodiment of the present invention, and FIGS. 13A-13E show signals that are output from components of the data layer determination unit 430, as shown in FIG. 12.

As shown in FIG. 12, the data layer determination unit 430 includes a first slice processing unit 432, a BPF 434, a second slice processing unit 436, a detection logic unit 438, and a data layer counter 439.

In particular, upon receipt of the total-sum signal RFDC to the first slice processing unit 432, for example, the first slice processing unit 432 compares the level of the total-sum signal RFDC with a predetermined first slice level shown in FIG. 13A. If the level of the total-sum signal RFDC is higher than the first slice level, a window signal outputs a high level signal as shown in FIG. 13B. In other words, a signal detected at (b) of FIG. 12 after passing through the first slice processing unit 432 is as shown in FIG. 13B.

Only a frequency component corresponding to a peak of the total-sum signal RFDC is filtered by the BPF 434 and the filtered component is amplified. Thus, the total-sum signal RFDC that undergoes band-pass filtering at (c) of FIG. 12 is output as a BPF signal as shown in FIG. 13C.

Upon receipt of the BPF signal to the second slice processing unit 436, the second slice processing unit 436 compares the level of the BPF signal with a second slice level, as shown in FIG. 13C. If the level of the BPF signal is lower than the second slice level, a layer count signal according to the BPF signal is high as shown in FIG. 13D. In other words, the BPF signal is binarized and a signal detected at (d) of FIG. 12 after passing through the second slice processing unit 436 is as shown in FIG. 13D.

Upon receipt of a window signal as shown in FIG. 13B and the layer count signal according to the BPF signal as shown in FIG. 13D, the detection logic unit 438 performs a logic operation on those two signals and thus outputs a final layer detection signal. Thus, a signal that is output from the detection logic unit 438 and detected at (e) of FIG. 12 is as shown in FIG. 13E.

In particular, the detection logic unit 438 performs an AND operation on the window signal as shown in FIG. 13B and the layer count signal as shown in FIG. 13D according to the BPF signal and outputs the layer detection signal as shown in FIG. 13E. The data layer counter 439 can determine the number of data layers of a loaded optical disk 10 based on the number of high levels of the layer detection signal.

Although the data layer determination unit 430 is included in the servo signal processing unit 400 according to the current example embodiment of the present invention, the data layer determination unit 430 may be implemented as a separate independent component.

As described above, according to the present invention, upon input of a focus jump command, spherical aberration correction with respect to a target data layer is first performed and the end point of time of the application of a kick pulse signal is determined using a total-sum signal RFDC instead of a focus error signal FES, thereby performing a focus jump rapidly and accurately. Moreover, by performing spherical aberration correction again after the focus jump, compatibility among various types of optical information storage media can be increased.

Various components of an optical disk recording/reproducing apparatus, as shown in FIG. 4, such as a RF amplification unit 200, a spherical aberration correction unit 300 and a servo signal processing unit 400, can be integrated into a single control unit, or alternatively, can be implemented in software or hardware, such as, for example, a field programmable gate array (FPGA) and an application specific integrated circuit (ASIC). Likewise, components of a data layer determination unit, shown in FIG. 12, can also be integrated and implemented by the same single control unit. As such, it is intended that the processes described herein be broadly interpreted as being equivalently performed by software, hardware, or a combination thereof. As previously discussed, software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Instructions of the software routines or modules may also be loaded or transported into the wireless cards or any computing devices on the wireless network in one of many different ways. For example, code segments including instructions stored on floppy disks CD or DVD media, a hard disk, or transported through a network interface card, modem, or other interface device may be loaded into the system and executed as corresponding software routines or modules.

In addition, the present invention can also be embodied as computer-readable code on a computer-readable recording medium. The computer-readable recording medium is any data storage device that can store data which can be thereafter read by a computer system. Examples of computer-readable recording media include read-only memory (ROM), random-access memory (RAM), CD-ROMs, magnetic tapes, floppy disks, optical data storage devices, and carrier waves. The computer-readable recording medium can also be distributed over a network of coupled computer systems so that the computer-readable code is stored and executed in a decentralized fashion.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. Accordingly, it is intended, therefore, that the present invention not be limited to the various example embodiments disclosed, but that the present invention includes all embodiments falling within the scope of the appended claims cm What is claimed is:

1. A method of controlling focusing onto an optical information storage medium having a plurality of data layers during an interlayer jump by moving an object lens up and down, the method comprising:
receiving a focus jump command for a focus jump from a current data layer to a target data layer of the information storage medium;
performing spherical aberration correction on the target data layer of the information storage medium;
holding a focusing servo with respect to the current data layer of the information storage medium; and
performing the focus jump to the target data layer of the information storage medium, by:
applying an acceleration pulse to a focus control signal for controlling driving of the object lens; and
terminating the application of the acceleration pulse, when a level of a sum signal resulting from the summation of the amplitude of light reflected from the information storage medium and collected is less than a predetermined level.

2. The method of claim 1, wherein the termination of the application of the acceleration pulse comprises terminating the application of the acceleration pulse, when the level of the sum signal is lower than an average level of the sum signal prior to the application of the acceleration pulse.

3. The method of claim 2, wherein the termination of the application of the acceleration pulse comprises terminating the application of the acceleration pulse, when the level of the sum signal for a data layer of the information storage medium immediately previous to the target data layer is lower than an average level of the sum signal prior to the application of the acceleration pulse.

4. The method of claim 3, wherein the performing of the focus jump comprises applying a signal of a level corresponding to the average level of the focus control signal prior to the application of the acceleration pulse to the focus control signal after the termination of the application of the acceleration pulse.

5. The method of claim 4, further comprising applying a deceleration pulse to the focus control signal, when the level of a focus error signal calculated from the amplitude of the light is lower than a first level.

6. The method of claim 5, wherein the first level is lower than the average level of the focus error signal prior to the application of the acceleration pulse.

7. The method of claim 6, wherein the amplitude of the deceleration pulse is reduced when a first time, from the end point of time of the application of the acceleration pulse to the start point of time of the application of the deceleration pulse, is longer than a reference time and the amplitude of the deceleration pulse is increased when the first time is shorter than the reference time.

8. The method of claim 1, wherein the performing of the spherical aberration correction on the target data layer comprises performing spherical aberration correction on at least one data layer between the current data layer and the target data layer of the information storage medium.

9. The method of claim 8, further comprising counting the number of data layers of the information storage medium after the spherical aberration correction with respect to the target data layer.

10. The method of claim 9, wherein the counting of the number of data layers comprises:
outputting a first signal resulting from comparison of the sum signal with a first slice level;
outputting a second signal resulting from band pass filtering with respect to the sum signal;
outputting a third signal resulting from comparison of the second signal with a second slice level;
outputting a fourth signal resulting from an operation with respect to the first signal and the third signal; and
determining the number of data layers of the information storage medium based on the fourth signal.

11. The method of claim 10, wherein the operation is an AND operation.

12. The method of claim 1 further comprising performing spherical aberration correction again after the focus jump.

13. The method of claim 1, wherein the light detector is a four-division photo-detector.

14. An optical information storage medium recording/reproducing apparatus comprising:
an optical pickup unit having an object lens and a light detector arranged to collect light reflected from a loaded optical information storage medium having a plurality of data layers by moving the object lens up and down;
a radio frequency (RF) amplification unit arranged to output a sum signal resulting from the summation of the amplitude of the collected light and a focus error signal resulting from another calculation on the amplitudes of the collected light;
a servo signal processing unit arranged to hold a focusing servo with respect to a current data layer of the information storage medium and performing a focus jump to a target data layer upon input of a focus jump command for the focus jump from the current data layer to the target data layer of the information storage medium;
a spherical aberration correction unit to perform spherical aberration correction on the target data layer of the information storage medium upon receipt of the focus jump command; and
a driving unit arranged to drive the optical pickup unit using a signal output from the servo signal processing unit,
wherein the servo signal processing unit applies an acceleration pulse to a focus control signal for controlling driving of the object lens and terminates the application of the acceleration pulse when the level of the sum signal is less than a predetermined level.

15. The apparatus of claim 14, wherein the servo signal processing unit terminates the application of the acceleration pulse, when the level of the sum signal is lower than an average level of the sum signal prior to the application of the acceleration pulse.

16. The apparatus of claim 15, wherein the servo signal processing unit terminates the application of the acceleration pulse, when the level of the sum signal for a data layer immediately previous to the target data layer is lower than an average level of the sum signal prior to the application of the acceleration pulse.

17. The apparatus of claim 16, wherein the servo signal processing unit applies a signal of a level corresponding to the average level of the focus control signal prior to the application of the acceleration pulse to the focus control signal after the termination of the application of the acceleration pulse.

18. The apparatus of claim 17, wherein the servo signal processing unit applies a deceleration pulse to the focus control signal, when the level of a focus error signal calculated from the amplitude of the light is lower than a first level.

19. The apparatus of claim 18, wherein the first level is lower than the average level of the focus error signal prior to the application of the acceleration pulse.

20. The apparatus of claim 19, wherein the amplitude of the deceleration pulse is reduced when a first time, from the end point of time of the application of the acceleration pulse to the start point of time of the application of the deceleration pulse, is longer than a reference time and the amplitude of the deceleration pulse is increased when the first time is shorter than the reference time.

21. The apparatus of claim 14, wherein the spherical aberration correction unit performs spherical aberration correction on at least one data layer between the current data layer and the target data layer of the information storage medium.

22. The apparatus of claim 21, further comprising a data layer determination unit arranged to count the number of data layers of the information storage medium after the spherical aberration correction with respect to the target data layer.

23. The apparatus of claim 22, wherein the data layer determination unit comprises:
a first slice processing unit to output a first signal resulting from comparison of the sum signal with a first slice level;
a band pass filter to output a second signal resulting from band pass filtering with respect to the sum signal;
a second slice processing unit to output a third signal resulting from comparison of the second signal with a second slice level;
a logic operation unit to output a fourth signal resulting from an operation with respect to the first signal and the third signal; and
a counter to count the number of data layers of the information storage medium based on the fourth signal.

24. The apparatus of claim 23, wherein the logic operation unit is an AND gate.

25. The apparatus of claim 14, wherein the spherical aberration correction unit performs spherical aberration correction again after the focus jump.

26. The apparatus of claim 14, wherein the light detector is a four-division photo-detector.

27. A computer-readable recording medium having recorded thereon a program for implementing claim 1.

28. An apparatus comprising:
an optical pickup unit having an object lens to irradiate a light beam onto an information storage medium having a plurality of data layers during a recording/reproducing operation, and a photo-detector to collect the light beam reflected from the information storage medium;
a driving unit to drive the object lens of the optical pickup unit to control a focus position of the light beam onto the information storage medium in response to a focus drive signal; and
a control unit arranged to perform logic operations of the light beam collected from the photo-detector to generate a focus error signal and a sum signal of amplitudes of the collected light beam, and to perform a focus jump from a current data layer to a target data layer of the information storage medium and a spherical aberration correction on the target data layer of the information storage medium, upon receipt of a focus jump command;
wherein the control unit further applies an acceleration pulse to the focus control signal for controlling driving of the object lens and terminates the application of the acceleration pulse to the focus control signal, when a level of the sum signal is less than a predetermined level.

29. The apparatus of claim 28, wherein the application of the acceleration pulse is terminated, when the level of the sum signal is lower than an average level of the sum signal prior to the application of the acceleration pulse.

30. The apparatus of claim 28, wherein the application of the acceleration pulse is terminated, when the level of the sum signal for a data layer immediately previous to the target data layer of the information storage medium is lower than an average level of the sum signal prior to the application of the acceleration pulse.

31. The apparatus of claim 28, wherein the control unit applies a signal of a level corresponding to the average level of the focus control signal prior to the application of the acceleration pulse to the focus control signal after the termination of the application of the acceleration pulse.

32. The apparatus of claim 28, wherein the control unit applies a deceleration pulse to the focus control signal, when the level of the focus error signal calculated from the amplitude of the light beam is lower than a first level, and the first level is lower than the average level of the focus error signal prior to the application of the acceleration pulse.

33. The apparatus of claim 32, wherein the amplitude of the deceleration pulse is reduced when a first time, from the end point of time of the application of the acceleration pulse to the start point of time of the application of the deceleration pulse, is longer than a reference time and the amplitude of the deceleration pulse is increased when the first time is shorter than the reference time.

34. The apparatus of claim 28, wherein the control unit is further arranged to count the number of data layers of the information storage medium after the spherical aberration correction with respect to the target data layer of the information storage medium.
